(19) United States
(12) Patent Application Publication
(10) Pub. No.: US 2012/0077180 A1
(43) Pub. Date: Mar. 29, 2012

(54) METHOD AND SYSTEM FOR KNOWLEDGE REPRESENTATION AND PROCESSING USING A STRUCTURED VISUAL IDEA MAP

(76) Inventors: AJAY SOHMSHETTY, CANTON, MI (US); ARCHANA SOHMSHETTY, CANTON, MI (US); RAJ SOHMSHETTY, CANTON, MI (US)

(21) Appl. No.: 12/890,673

(22) Filed: Sep. 26, 2010

(51) Int. Cl. G09B 29/00

(52) U.S. Cl. 434/430

(57) ABSTRACT

A method and system for knowledge representation and processing using a structured visual idea map that allows the processing of information and viewing of information in different formats and perspectives, encouraging users to enumerate and connect concepts without a tendency to begin within a particular conceptual framework, think in a systematic way and distinguish between relevant information. The present invention can be used for presenting information in a logical manner for serious information and knowledge transfer and providing feedback on thoughts/opinions. Information can be shown in different perspectives to alter amount of information.

### FIELD OF THE INVENTION

The present invention relates to the field of methods and systems for idea mapping and more particularly to a method and system for knowledge representation and processing using a structured visual idea map.

### BACKGROUND OF THE INVENTION

Various techniques for computer-based knowledge representation and processing are widely used. Several knowledge representation and processing techniques based on a symbolic and semantic approach have been used. Knowledge representation and processing are restricted to manipulating symbols in the form of, for instance, bit patterns. It is the external human user who ascribes semantic values to these symbols by interpreting them through interactions with the environment.

A knowledge representation is most fundamentally a surrogate, a substitute for the thing itself, used to enable an entity to determine consequences by thinking rather than acting, i.e., by reasoning about the world rather than taking action in it. It is a fragmentary theory of intelligent reasoning, expressed in terms of three components: (i) the representation's fundamental conception of intelligent reasoning; (ii) the set of inferences the representation sanctions; and (iii) the set of inferences it recommends. It is a medium for pragmatically efficient computation, i.e., the computational environment in which thinking is accomplished. One contribution to this pragmatic efficiency is supplied by the guidance a representation provides for organizing information so as to facilitate making the recommended inferences (seems like this paragraph was copied from somewhere—should cite reference)

In the 1980s formal computer knowledge representation languages and systems arose. Major projects attempted to encode wide bodies of general knowledge. In computer science, particularly artificial intelligence, a number of representations have been devised to structure information. Since knowledge is used to achieve intelligent behavior, the fundamental goal of knowledge representation is to represent knowledge in a manner as to facilitate inference from knowledge.

Knowledge representation is most commonly used to refer to representations intended for processing by modern computers, and in particular, for representations consisting of explicit objects (the class of all mice, or Sam a certain individual), and of assertions or claims about them (‘Sam is a mouse’, or ‘all mice are black, white or grey’). Representing knowledge in such explicit form enables computers to draw conclusions from knowledge already stored (‘Sam is black, white or grey’).

An idea map is a diagram used to represent words, ideas, tasks, or other items linked to and arranged around a central key word or idea. Idea maps are used to generate, visualize, structure, and classify ideas, and as an aid to studying and organizing information, solving problems, making decisions, and writing. The elements of a given idea map are arranged intuitively according to the importance of the concepts, and are classified into groupings, branches, or areas, with the goal of representing semantic or other connections between portions of information. Idea maps may also aid recall of existing memories.

By presenting ideas in a radial, graphical, non-linear manner, idea maps encourage a brainstorming approach to planning and organizational tasks. Though the branches of an idea map represent hierarchical tree structures, their radial arrangement disrupts the prioritizing of concepts typically associated with hierarchies presented with more linear visual cues. This orientation towards brainstorming encourages users to enumerate and connect concepts without a tendency to begin within a particular conceptual framework.

Idea mapping consists of a map tile, which holds the subject the map by filling in the thoughts the user may have about the subject, describing that thought in more detail. That viewing representations in this system has consequences for both research and practice.

The current situation in knowledge representation and processing is the use of traditional textbooks or online textbooks which feature hyperlinked information and graphical ways of presenting information such as the traditional idea map. However, none of these methods completely utilize the potential of the world wide web and the Internet as a powerful social knowledge analysis and learning tool. For example, students in a high school Advanced Placement US History class use several books and online resources to learn US History from different perspectives and critically analyze the events and outcomes. Often, there will be multiple views of the same information and debates about factuality and objectivity of different pieces of information. Moreover, information and opinions about the information change over time; and there is no simple way of tracking these changes. Also, there is a need for a tool to help students comprehend and visually analyze scholarly writings.

A number of approaches for visually representing information have been used. They include mind maps, idea maps, concept maps, argument maps, and symantic networks. In general, all of these traditional approaches tend to be too free form with little or no structure. While these approaches are useful for idea generation and organization, they all lack the features and multi-dimensional logic analysis required for complex knowledge representation and processing.

Accordingly, improvements are needed in the existing methods and systems to negate the above shortcomings in the existing methods and systems.

The relevant prior art methods, which will deal with knowledge information and processing, are as follows:

U.S. Pat. No. 5,122,952 describes a computer assisted-method and apparatus for automated leaning tool selection for children development. The learning needs of individual children differ because of differences in the development stages. Information concerning a child's sensory learning style preferences, hobbies and interests, academic conditions, medical conditions, social habits, emotional attitudes, and nutritional habits is entered into the computer system. The system compiles the child data into report. The system also matches the child data with the product data and list of preferred products is produced from which parent's select appropriate learning tools for the child.

U.S. Pat. No. 5,863,208 claims a computer-aided educational system and method. The system selects a un-learnt line-item, generates detailed learning materials for the un-learnt line-item. The present invention is applicable to teach any subject that can be taught by a computer. The subject may cover inter-disciplinary areas, such as electrical engineering and thermodynamics, or computer networking and programming techniques.

U.S. Pat. No. 6,273,726 describes an audio-visual work and method which work has writings placed on the pictures of the work so that as each word or other utterance is heard a writing to be associated with the hearing coordinated with seeing of the writing such that the future presentation of either the utterance or the writing shall evoke the other in the mind of the original viewer-listener. The word when appropriate then appears in a legible perspective adjacent to the mouth of the utterer. The work can be displayed linearly or under computer control of the viewer/listener along with additional educational materials.

U.S. Pat. No. 6,370,355 discloses an internet based leaning system to a student providing educational tool in accordance with students expressed educational interests. The blended learning system uses multiple educational tools that providing the end-user with complete and efficient educational lessons. Educational tool is focused upon a knowledge area in which student has educational interest. The invention is implemented by means of non-hierarchical network having a fractal structure.

U.S. Pat. No. 6,527,556 claims a method and system of creating, delivering and administering training materials. The system provides administrative management of the learning process. It permits the development of large interactive content without requiring authoring experts. An integrated learning environment containing authoring, interactive learning and administrative functions that may implemented in a client-sever or application service provider (“ASP”) environment such as internet.

U.S. Pat. No. 7,152,034 describes procedures/routines to teach certain repertoires, such as reading, to learners without a teacher present. The various routines can be provided or implemented via computer network, such as internet so the multiple learners can access and use the routines. The routines may be implemented in a sequence of episodes, with each episode systematically building on the particular skills learned in a prior episode.

U.S. Pat. No. 7,536,376 describes a method to assist system administrations and other support personnel in the retrieval of task related log records. A user command communicating at least one log record search key is received from a user. A first set of one or more log records matching the log record search key is retrieved. A second set of one or more log records matching the additional search criteria is retrieved from the DMBS log file wherein this second set of log records is logically related to the first set of log records and wherein the second set of log records is void of the log record search key.

US Patent No. 20020161732 describes educational software that functions using a computer and having a data storage system including software module database management system and a use database management system. This invention provides computer based methods and systems for creating and evaluating quizzes and for creating structured leaning materials which define the structure matter of the quizzes.

US Patent No. 20020187462 discloses an internet based teaching system. The educational tool is divided into thee grade levels of elementary school, middle school and the high school. After selecting among various activities, including classroom, home work, portfolio, fun activities, friends and gallery, which are all designed to be appropriate for the grade level selected. The classroom activity includes tutorials and exercises to help the student attain his educational goals.

US Patent No. 20020058236 claims a computer-assisted method of special education for individuals with learning difficulty. Which accommodate each individual learner's special need by allowing a dynamic setup pf teaching material such as its content and level of difficulty, by remembering each individual learners leaning skills and learning progress and by providing rewards based on each individual learners actual performance with an adjustable rewording threshold to suit each learner current liability.

US Patent no. 20020098463 describes a computer based method of providing reading instruction to a student. The software program implemented in a computer based environment provides balance approach to reading based on different programmed components namely phonetic awareness reading subskills and reading comprehension.

US Patent No. 20040015813 claims a system for interactive training, learning and entertainment. The system includes a use operable data processing and display device designed and configured to operate a software simulator. The software generates, and simulates operation of, at least one organization. The software simulators used for training, learning and entertainment and more particularly a method and system for multi-scenario interactive competitive and non-competitive training, learning and entertainment using software simulators featuring multi-scenario interactive competitive and non-competitive dynamics.

US Patent No. 20050158698 discloses an internet enabled subscription teaching service system has an internet-connected lecture server executing a software suite, one or more teacher-author stations coupled to the internet-connected lecture sever, having input and display apparatus, and including lecture-authoring software, and one or more Internet capable lecture client stations having lecture-participations software. the interactive online communication and has particular application to methods including software for creating and conducting interactive lectures via internet or the other wide-area net-work (WAN).

US Patent No. 20060099562 describes a system and method of learning through computer program product providing learning tool. The user can select any subject to learn. The learning tool in the computer program is available by means of a communication network such as internet. The invention provides user access at any desired point or location.

US Patent No. 20070238077 describes a computerized interactive teaching and learning tool for interactive learning of techniques, reading speed and comprehension. A main menu includes reading gym and reading theatre along with other active zones. The active zones allow the user to select various exercises, games and tests. The system involves innovative and interactive methods of displaying text in ways to expand the reading speed and comprehension of the user, while providing visual and audio background to enhance learning.

US Patent No. 20070269778 claims a learning system comprising database for storing predetermined articles having embedded linguistic hypertext links, vocabulary, grammatical rules and grammatical data. This invention provides learning systems for teaching a student the conventions of standard written English. Wherein, selection of embedded linguistic hypertext links in the article provides a contextual explanation that teaches a student the conventions of standard written English.

US Patent No. 20080108035 describes a perpetual software-application that provides customized, ongoing and unlimited tutoring based on a database designed to provide a comprehensive knowledge resource for the area of study and a user database that maintains a individual learning profile quizzes based on the student's preferences, needs and prior quiz data.

US Patent no. 20080208885 claims a method for creating and tracking external data via idea map. A idea mapping system uploads the data to an external system and tracks changes to such data in the external system through idea map. By classifying topics in the idea map user can create data objects in an external system. The user can track the changes made to the data in the external system through the idea map.

US Patent No. 20080220399 provides a cognitive educational tool for effectuating learning. The tool encourages the development of the student-teacher rapport levels and thus promotes the ability to acquire and retain functional techniques and information. The tool is preventive in nature, is also culturally, cognitively, age appropriate, gender and scenario flexible. The process is designed to increase participant's level of competency when encountering situations, which impact their social development and/or success in real life situations.

US Patent No. 20090061399 describes a system, method and a computer readable medium for providing virtual learning of academic topic unrelated to languages in a non-native language of a student. This invention provides virtual learning for learning and teaching academic topics based on the user input and an output device, which outputs the academic topic provided by the processor to a user. Upon user request, the continuous providing of the academic topic is paused and at least one key term of the academic topic is provided in the native language.

US Patent No. 20090217196 discloses web based tool for collaborative social learning. a computerized social network provides a community of users with features and tools facilitating an immersive, collaborative environment where users can lean a language or help others learn a language. One use can view another user's web page or document and make suggestions or comments for selected content on the web page. These suggestions are linked specifically to the selected content. User B can view the suggestions, and accept or reject the suggestions by user A and others.

However the purpose and methodology of all the above inventions that are part of prior art do not envisage the unique embodiment of knowledge representation and processing using a structured idea map described in this invention.

The present invention envisages the use of structured visual idea maps to allow the processing of information and viewing of information in different formats. Information can be shown in different perspectives to alter the amount of information shown at a time. The present invention further forces user to think in a systematic way. For example, structured idea maps as used by the present invention consist of information in the form of journalistic 4Ws (What, When, Where, and Who).

The present invention provides various knowledge processing techniques that enable computers to draw conclusions from knowledge already stored. The present invention envisages a framework for a unified and coordinated treatment of multiple logical classifications of information in a single environment. Information is presented with varying complexity for serious information and knowledge transfer. Further, social collaboration of information provides feedback on thoughts/opinions.

The present invention thus meets the drawbacks existing in the art by providing for structured visual idea maps through which represented information can be easily accessed and processed and understood.

Further, it will be apparent to those skilled in the art that the objects of this invention have been achieved by providing a method and system for knowledge representation and processing using a structured visual idea map which is different from existing methods and systems that are suited only for limited purposes. Various changes may be made in and without departing from the concept of the invention. Further, features of some stages disclosed in this application may be employed with features of other stages. Therefore, the scope of the invention is to be determined by the terminology, and the legal equivalents thereof.

### SUMMARY OF THE INVENTION

This present invention may be summarized, at least in part, with reference to its objects.

The foremost object of this invention is to provide a method and system for effective and easily accessible and comprehendible knowledge representation and processing using a structured visual idea map.

Another object of the present invention is to provide a method and system of using a structured visual idea map for knowledge representation and processing that allows viewing of such information in different formats including but not limited to presentation in format such as timeline, outline and report.

Another object of the present invention is to provide a method and system of using a structured visual idea map for knowledge representation and processing where the information in the description can be represented in different perspectives to alter amount of information shown at a time including but not limited to toggle between views of more/less info.

Another object of the present invention is to provide a method and system of using a structured visual idea map for knowledge representation and processing that facilitates systematic thinking in the manner of what, when, where, who, why.

Another object of the present invention is to provide a method and system of using a structured visual idea map for knowledge representation and processing that can distinguish between relevant information in various ways including but not limited to biased/objective, fact/opinions, and popularity ratings.

Another object of the present invention is to provide a method and system of using a structured visual idea map for knowledge representation and processing that provides for social collaboration to provide feedback on thoughts/opinions.

Another object of the present invention is to provide a method and system of using a structured visual idea map for knowledge representation and processing that allows the user to visually view the relationships between ideas and events.

Another object of the present invention is to provide a method and system of using a structured visual idea map for knowledge representation and processing that is practical in implementation.

A further object of the present invention is to provide a method and system of using a structured visual idea map for knowledge representation and processing that can be easily accessed online.

These and other objects and advantages and features of the present invention will be more readily apparent when considered in reference to the following description.

In accordance with the foregoing, the present invention comprises a method and system of knowledge representation and processing that is automatic and easily accessible online on a designated website on the user's web browser. The data representation through the structured visual idea maps in the present invention is well structured and easily understandable. The structured visual idea maps in the present invention can be thus used for presenting complex information and facilitate effective knowledge transfer.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description and when taken in conjunction below.

### DESCRIPTION OF THE DRAWINGS

FIG. 1 is a flow chart diagram depicting the components of a structured visual idea map as envisaged by the present invention.

FIG. 2 is a flow chart diagram depicting the components of a structured visual idea map idea box.

FIG. 3 is a flow chart diagram depicting the components of a structured visual idea map idea box consisting of facts or opinions.

FIG. 4 is a flow chart diagram depicting the effective use of connectors in the present invention.

FIG. 5 is a flow chart diagram depicting a structured visual idea map page.

FIG. 6 is a schematic flow chart diagram depicting the idea data processing module.

FIG. 7 is a schematic flow chart diagram depicting the relationship data processing module.

### DETAILED DESCRIPTION OF THE INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

The following description is presented to enable any person skilled in the art to make and use the invention, and is provided in the context of particular applications of the invention and their requirements. The present invention can be configured as follows:

The structured visual idea maps envisaged in this invention enable knowledge representation and processing of information given by the user.

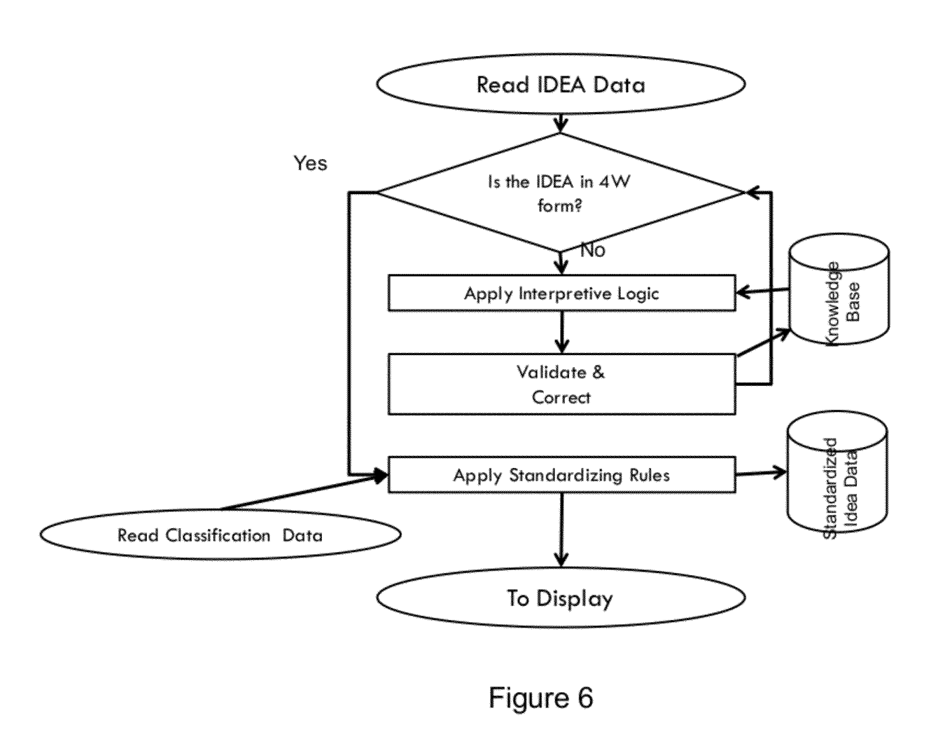

As laid out in FIG. 6, the present method includes receiving data on a logical classification of the ideas, analyzing whether the idea data is in 4W form, if not then applying interpretive logic to standardize the idea data into journalistic 4W (What, When, Where, and Who) categories, reading classification data and creating a display of the ideas as idea boxes (3) using the standardized visual display characteristics and showing name/title and one or more of the information categories: What, When, Who, and Where.

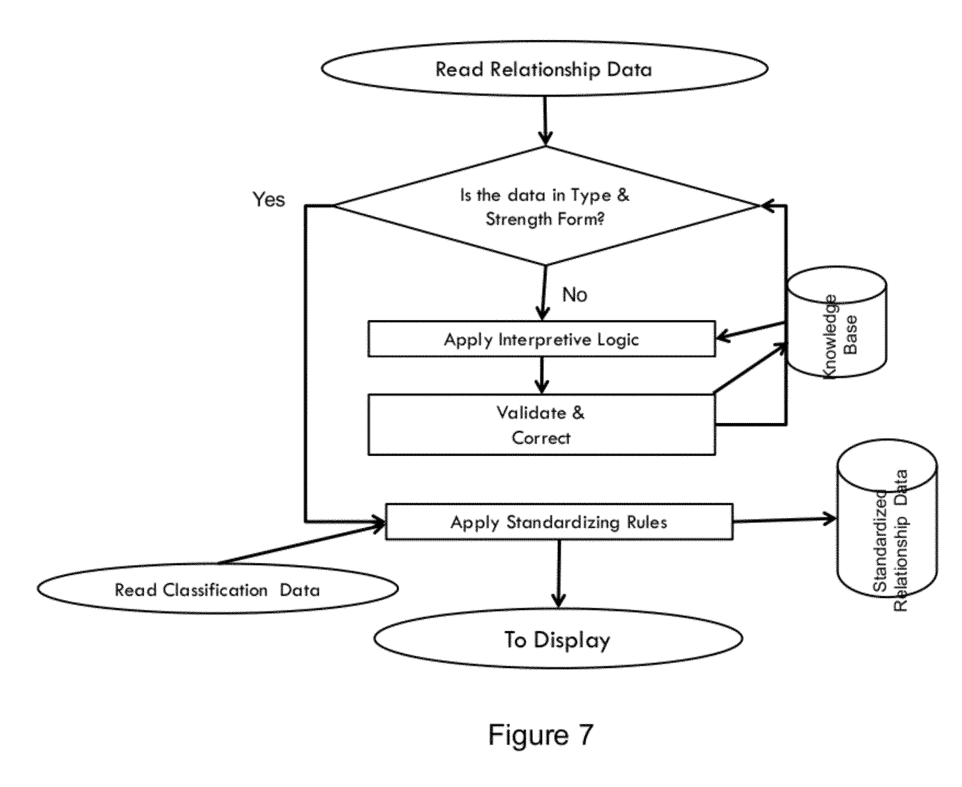

As laid out in FIG. 7, the present method includes receiving data on a logical classification of the relationships, applying interpretive logic to standardize the relationship data into type of relationship and strength of relationship categories, applying standardizing rules to generate the visual display characteristics of the ideas based on their logical classification and their strength values, creating a display of the ideas as idea boxes (3) using the standardized visual display characteristics and displaying the relationships among the idea boxes (3) as lines or arrows (12) using the standardized visual display characteristics.

As illustrated the present invention provides a method and system for processing and displaying visual idea maps receiving data on a plurality of ideas and on a plurality of relationships among the ideas.

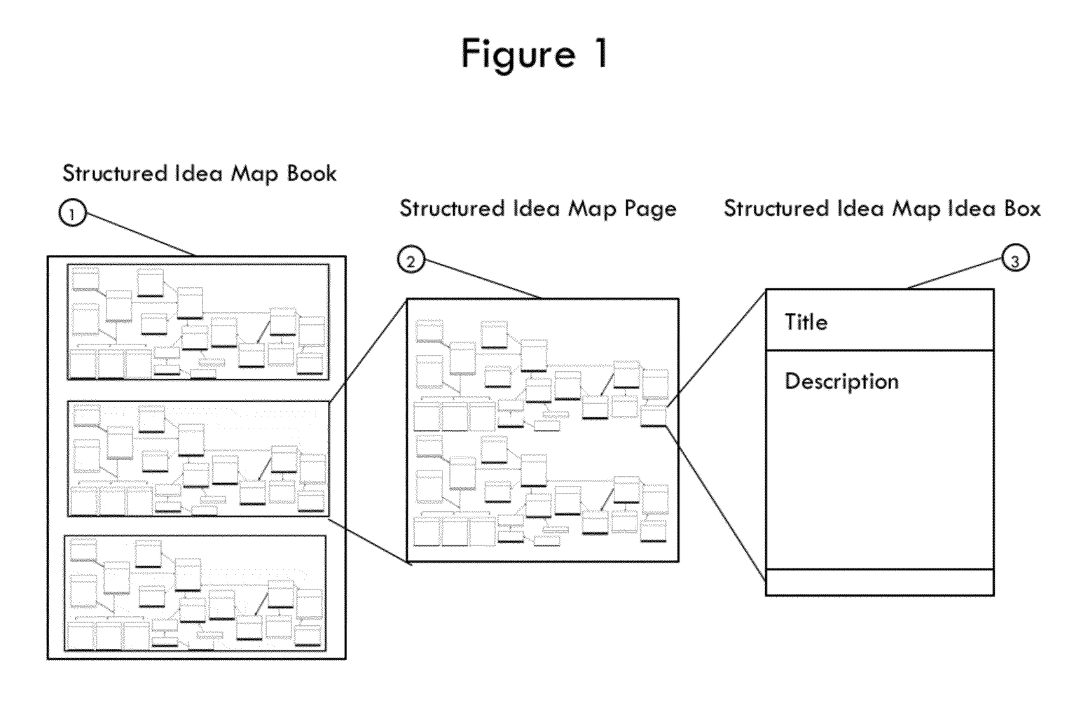

FIG. 1 illustrates the composition of a structured visual idea map book (1), that can be made accessible through a pay to access service, and that consists of several structured visual idea map pages (2), each individual page consisting of several structured visual idea map idea boxes (3).

In the preferred embodiment of this invention, users can easily access the structured visual idea maps of the present invention online through Internet.

By accessing the designated website, the user may create a structured visual idea map himself, or choose to purchase/view another structured visual idea map.

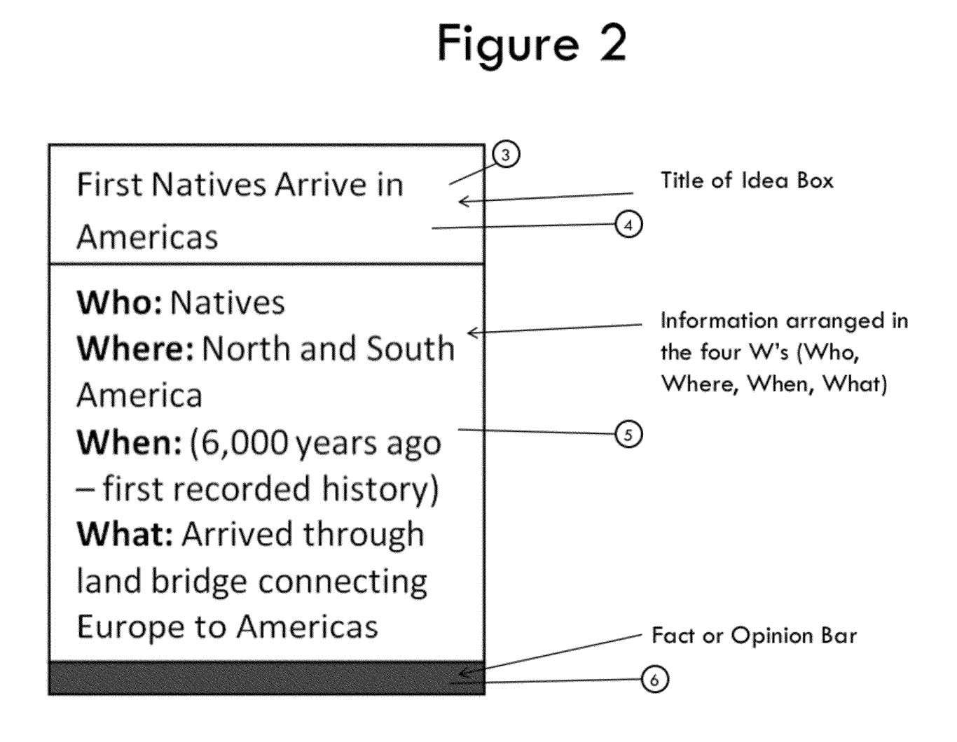

As depicted in FIG. 2, a structured visual idea map consists of a collection of idea boxes (3), which in turn is made up of a Title Bar (4), an Information description Bar (5) and a Fact or Opinion Bar (6). The logical classification of the idea boxes (3) are as one or both of fact/opinion and objective/biased. Thus one or more overall measures of factuality and objectivity of the idea map is calculated and reported based on the factuality and objectivity values of the individual idea boxes (3) and connectors (12) contained in such idea map.

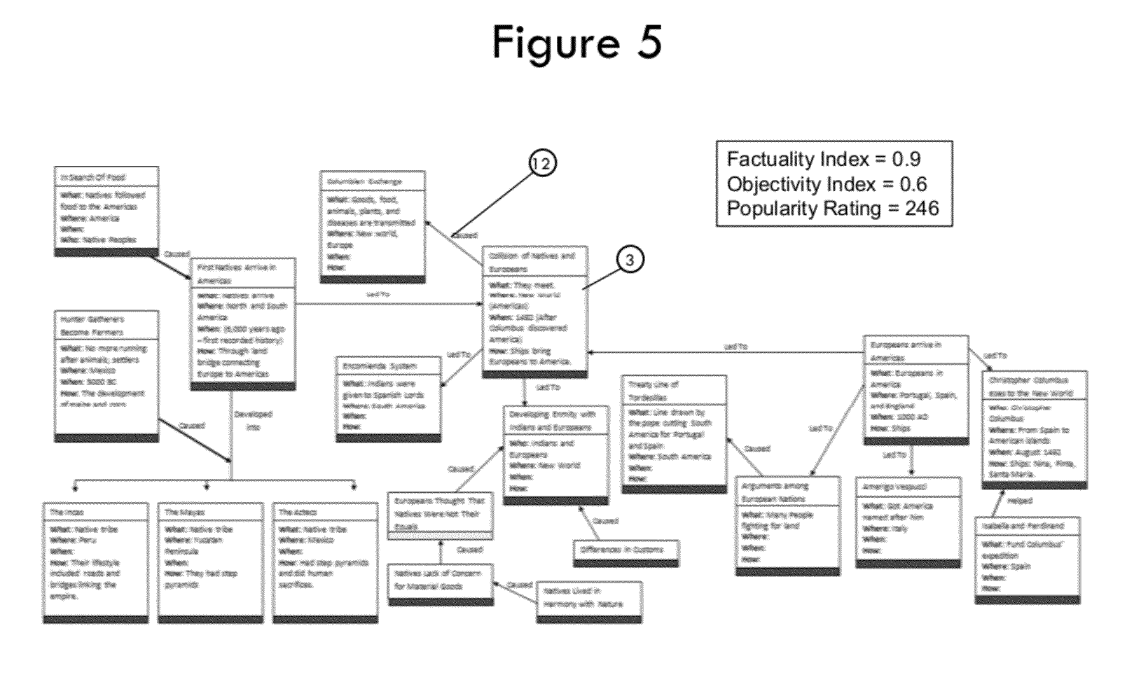

As illustrated in FIG. 5 lines/arrows are used as connectors (12) between one idea box (3) and another idea box (3) to show a relationship between them. The thickness of the connectors may be used to describe the strength of the relationship between the idea boxes (3). Connectors (12) also may change color and texture based on whether the relationship is a fact or opinion.

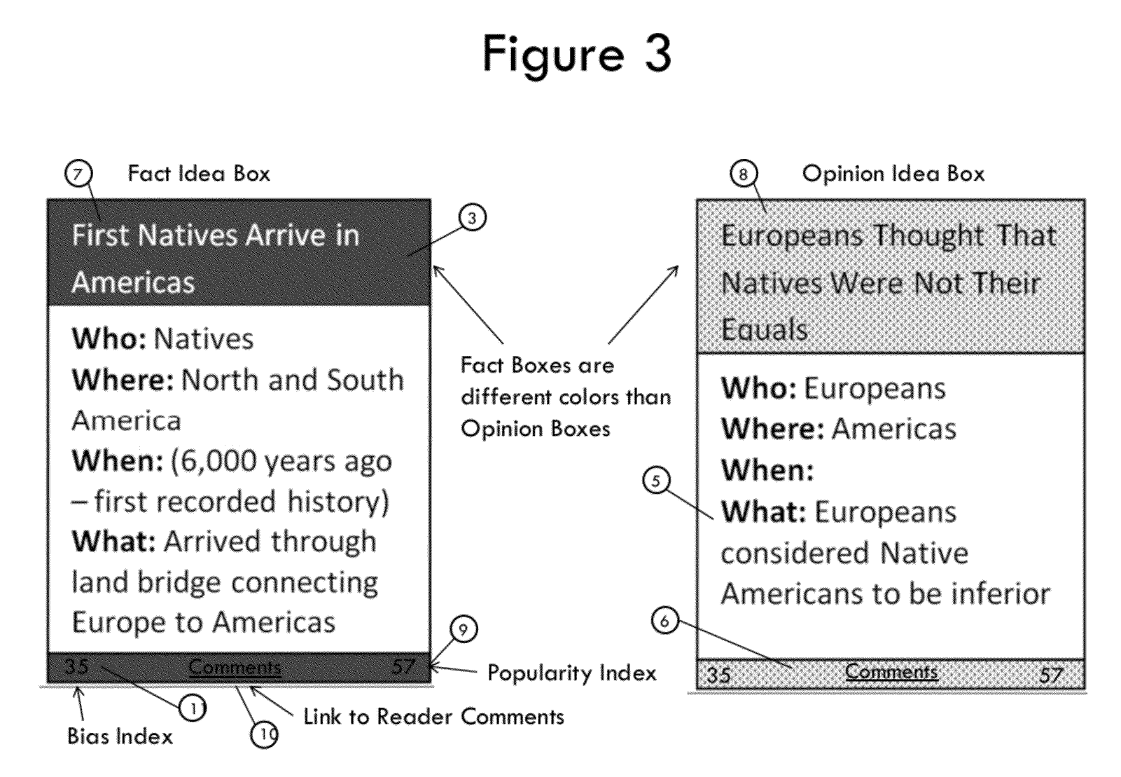

FIGS. 2 and 3 show the use of the idea box (3) to represent nouns, subjects and objects of the data. As shown in FIGS. 1, 2, 3, 4 and 5, connectors (12) represent verbs and adverbs. FIG. 3 demonstrates the differentiation of idea boxes (3) for facts (7) and opinions (8) by color effect and texture of visual idea map elements including but not limited to text color, text size, background color, and background texture. Again, the connectors (12) specify relationships between idea boxes (3) as represented by the visual characteristics of the connectors (12) including but not limited to line type, line color, and line thickness.

As illustrated in FIGS. 2 and 3, idea boxes (3) are organized by the journalistic 4 Ws, namely, What, When, Where, Who for the specific information in the data. This form of representation of information in the information description bar (5) of the idea box (3) stimulates user to think in a systematic manner.

In one embodiment of the present invention as provided in FIG. 2, if the user provides “Natives arrived in Americas 6000 years ago through a land bridge” in the title bar (4) then idea boxes will appear with systematically organized information as per the 4 W's (What, When, Where, Who) in the information description bar (5):
What: Natives arrived in Americas 6000 years ago through a land bridge.
Who: Natives
Where: Americas
When: 6000 years ago

If the user provides an opinion in the title bar (4) of an opinion idea box (8) e.g.—“Europeans thought that natives were not their equals”, then the information arranged by the 4 W's may be as follows in the information description bar (5) in the opinion idea box (8).
What: Europeans considered Native Americas to be inferior
Who: Europeans, Native Americans
Where: Americas

As laid out in FIG. 3, to differentiate the fact idea boxes (7) and the opinion idea boxes (8), different color and/or texture may be used throughout the structured visual idea map.

The Fact or Opinion Bar (6) shows the Popularity Index (9) which reflects the number of users who viewed/liked the data. Link to Reader Comments (10) in the Fact or Opinion Bar (6) provides a link that the user can access to view comments posted by other users and to post their own comments regarding the data. The Fact or Opinion Bar (6) also shows a Bias Index (11) that provides the amount of bias element present in various opinions recorded, which helps the user to visually ascertain the amount of bias and form his own view of the information depicted in the idea box (3). The present invention method thus envisages calculating and reporting one or more overall measures of popularity of the idea map based on the popularity values of the individual idea boxes (3) and connectors (12) contained in the idea map and calculating and reporting change of the popularity metrics of the idea map over time.

The data from the idea boxes (3) in the present invention is further processed to create flashcards by randomly selecting an idea from the data source and one of the 4W (What, When, Who, and Where) data fields and assigning the value in the field as the correct answer, followed by selecting values for the same field from one or more other ideas in the data source and using these as alternate answer choices. The correct answer and the answer choices are then standardized and the selected idea is displayed masking the value of the selected data field. The correct answer and the alternate answer choices in a random sequence is also displayed. Toggling is done between displaying views of more or less information in the idea boxes (3). The display unit of the present invention can be configured to allow zoom and pan of the visual idea map.

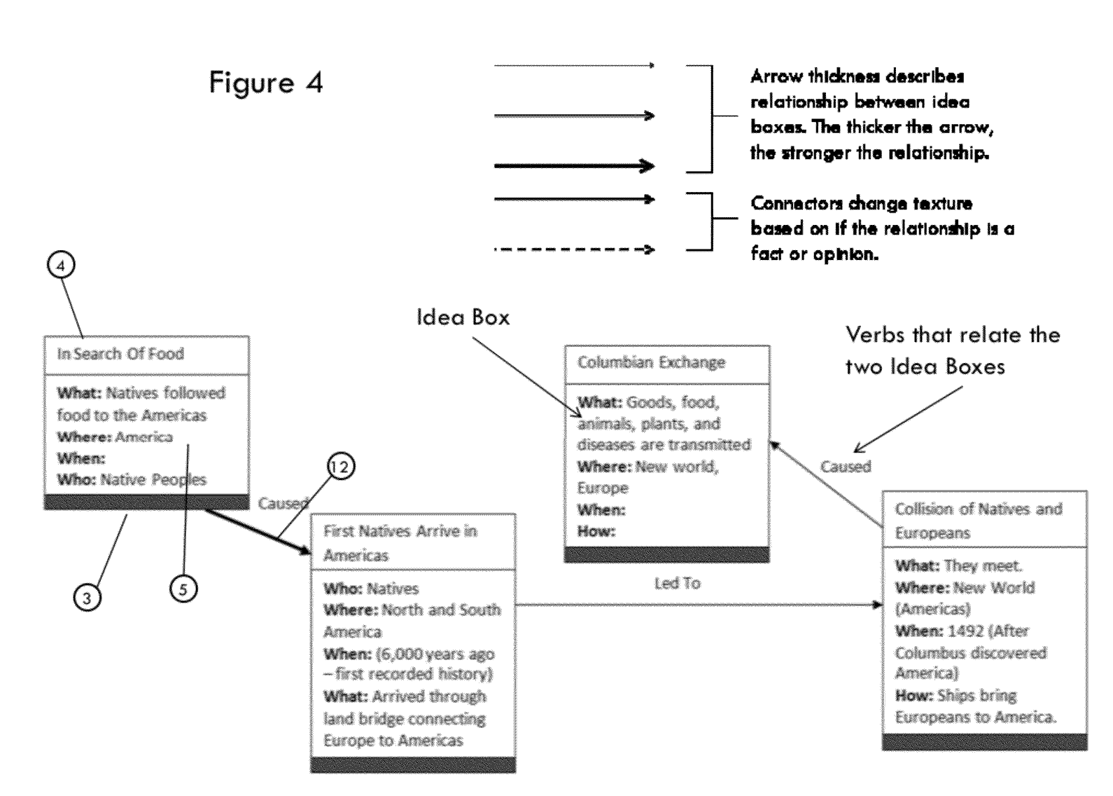

Another example of an idea box is illustrated in FIG. 4. The title bar (4) of the idea box (3) states “In Search Of Food” and in the information description bar (5) the information may be arranged by the 4w's as follows:
What: Natives followed food to the Americas
Where: America
When: 6000 years ago
Who: Natives

The next idea box (3) which depicts the causation of the above idea box (3) states in the title bar (4) “Natives Arrive in Americas” for which the information will be arranged by 4Ws in the information description bar (5) as follows:
What: Natives arrived in Americas 6000 years ago through a land bridge
Who: Natives
Where: Americas
When: 6000 years ago

The thickness of the connector (12) connecting the first idea box to the second denotes the strength/importance of the relationship of these two idea boxes (3).

From this idea box (3) a connector (12) connects to a third idea box representing the verb that relates the two idea boxes (3). The title bar (4) of the third idea box (3) states “Collision of Natives and Europeans” for which information is arranged in the information description bar (5) as follows:
What: Ships bring Europeans to America after Columbus discovered America
Who: Europeans
Where: America
When: After Columbus discovered America

From the third idea box (3) a connector (12) leads to a fourth idea box (3) representing the verb caused. The title bar (4) of the fourth idea box (3) reads “Columbian Exchange” for which information is arranged in the information description bar (5) as follows:
What: Goods, food, animals, plants, and diseases are transmitted.
Where: New World, Europe
When: 1500s
Who: Native Americans, Europeans

This representation of Idea boxes (3) with relevant Connectors (12) throughout the structured visual idea map gives the user detailed information on a particular area through the arrangement of parallel strings of data in each idea box (3) in a systematic manner. Therefore, the structured visual idea map, when unfolded, lays open all possible data relating to a particular topic and is easily understandable due to the effective use of connectors (12). The data from the idea boxes (3) and connectors (12) is processed to create quizzes with questions and answers, textual summaries, time charts, etc.

The present invention enables classification of information into logical categories such as biased/objective, fact/opinions, etc. The present invention is an advancement over traditional mind mapping and idea mapping methods since the traditional methods:
a) Do not present information in the journalistic 4W format
b) Cannot be changed into different formats whereas the structured visual idea map of the present invention can be changed into different formats based on criteria including but not limited to timeline, flashcards, outlines, etc.
c) Do not provide a method for logical classification of information, whereas in the structured visual idea map of the present invention visually differentiates between facts and opinions, biased and objective, etc.
d) Do not show the strength of the relationships between each idea map component, whereas in the structured visual idea map of the present invention, connectors (12) are effectively used to shows the strength of the relationship between the components (idea boxes 3) of the structured visual idea map.
e) Do not provide for estimating overall measures of factuality, objectivity, and popularity of the ideas.

Again on comparing the structured visual idea map of the present invention with argument idea map, concept idea map and semantic networks, the following advancements are seen.
a) Argument Maps are one sided, they don't contain a variety of opinions, do not show the cause and effect of each part, and only have one purpose, and that is to convince or show supporting arguments, whereas the structure visual idea map of the present invention shows an overall view of the entire topic.
b) Concept Maps do not show opinions, or how strong the connections are, and each bit of the Concept Map doesn't have a lot of information unlike the systematic representation and processing of information in the idea boxes (3) of the structured visual idea map of the present invention.
c) Semantic Networks cannot show opinions, do not show strong connections between bits, do not show cause and effect and each bit doesn't have a lot of information unlike the systematic representation and processing of information in the idea boxes (3) of the structured visual idea map of the present invention.

Thus traditional idea maps are only used for presenting information with limited complexity, whereas the structured visual idea map of the present invention allows the systematic representation and processing of knowledge information in idea boxes having different formats, various view options, facts/opinions differentiation and use of connectors.

Further is outlined in general, the physical aspects of the present invention, to serve as an aid to better understanding the intended use and application of the present invention. The invention may be embodied by a computer program product embodied in a computer readable medium for processing and displaying visual idea maps of the present invention, comprising one or a plurality of computers configured to receive data on a plurality of ideas, one or a plurality of data storage devices configured to store the idea map and related data and one or a plurality of display units configured to create a display of the said ideas as idea boxes (3) using the standardized visual display characteristics and showing name/title and one or more of the following predefined information categories, and that is executed by a processor within a computer as a series of computer-executable instructions. The examples of encryption and decryption specifically point out preferred embodiments of the present invention, and are not to be construed as limiting in any way the remainder of the disclosure. Various user computers configured to operate in a distributed computer system network are connected to a plurality of web servers by means of the Internet. The web pages are maintained in the web servers and are downloaded to user computers by means of the Internet. Such examples are non-limiting in that one of ordinary skill (in view of the above) will readily envision other permutations and variations on the invention without departing from the principal concepts. Such permutations and variations are also within the scope of the present invention.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of this invention have been achieved by providing the above invention. However various changes may be made in the structure of the invention without departing from the concept of the invention. Therefore, the scope of the invention is to be determined by the terminology of the above description and the legal equivalents thereof.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

We claim:

1. A computer-implemented method of processing and displaying information as a visual idea map comprising the steps of:
receiving data on a plurality of ideas;
receiving data on a plurality of relationships among the said ideas;
receiving data on a logical classification of the said ideas and the said relationships;
applying interpretive logic to standardize the said idea data into journalistic 4W (What, When, Where, and Who) categories;
applying interpretive logic to standardize the said relationship data into type of relationship and strength of relationship categories;
applying standardizing rules to generate the visual display characteristics of the ideas based on their logical classification;
applying standardizing rules to generate the visual display characteristics of the relationships based on their logical classification and their strength values;
creating a display of the said ideas as idea boxes using the standardized visual display characteristics and showing name/title and one or more of the following predefined information categories: What, When, Who, and Where;
creating a display of the said relationships among the said idea boxes as lines or arrows using the standardized visual display characteristics;

2. The computer-implemented method of claim 1, wherein the logical classification categories are one or both of: fact/opinion and objective/biased.

3. The computer-implemented method of claim 1, wherein the said idea box further comprises a measure of popularity and reader comments.

4. The computer-implemented method of claim 2, further comprising the steps of calculating and reporting one or more overall measures of factuality and objectivity of the idea map based on the factuality and objectivity values of the individual idea boxes and connectors contained therein.

5. The computer-implemented method of claim 3, further comprising the steps of calculating and reporting one or more overall measures of popularity of the idea map based on the popularity values of the individual idea boxes and connectors contained therein.

6. The computer-implemented method of claim 5, further comprising the steps of calculating and reporting change of the popularity metrics of the idea map over time.

7. The computer-implemented of claim 1, wherein the visual display characteristics of idea boxes and relationships include one or more of text color, text size, background color, background texture, line type, line color, and line thickness.

8. The computer-implemented method of claim 1, wherein the data from the idea boxes is further processed to create flashcards comprising the steps of:
randomly selecting an idea from the data source;
randomly selecting one of the 4W (What, When, Who, and Where) data fields and assigning the value in the field as the correct answer;
selecting values for the same field from one or more other ideas in the data source; and using these as alternate answer choices;
standardizing the correct answer and the answer choices;
displaying the selected idea masking the value of the selected data field;
displaying the correct answer and the alternate answer choices in a random sequence;

9. The computer-implemented method of claim 1, wherein one or more related visual idea maps are organized into a visual idea map book.

10. The computer-implemented method of claim 9, wherein a visual idea map book is made accessible through a pay to access service.

11. The computer-implemented method of claim 1, further comprising toggling between displaying views of more or less information in the idea boxes.

12. The computer-implemented method of claim 1, wherein the data from the idea boxes and connectors is processed to create quizzes with questions and answers.

13. The computer-implemented method of claim 1, wherein the data from idea boxes and connectors is further processed to create textual summaries.

14. The computer-implemented method of claim 1, wherein the data from the idea boxes is further processed to create time charts comprising the steps of:
standardizing the When data from idea boxes;
standardizing the relationship data;
applying interpretive logic to When data and relationship data to order the idea boxes in a chronological order;
displaying the ideas on a time chart;

15. The computer-implemented method of claim 1, wherein the data for the said idea boxes and connectors is changed dynamically through user inputs.

16. The computer-implemented method of claim 1, wherein said idea boxes represent nouns, subjects and objects of the data with said connectors represent verbs and adverbs.

17. A computer-implemented system for processing and displaying information as a visual idea map comprising:
at least one computer configured to:
receive data on a plurality of ideas; receive data on a plurality of relationships among the said ideas; receive data on a logical classification of the said ideas and the said relationships; apply interpretive logic to standardize the said idea data into journalistic 4W (What, When, Where, and Who) categories; apply interpretive logic to standardize the said relationship data into type of relationship and strength of relationship categories; apply standardizing rules to generate the visual display characteristics of the ideas based on their logical classification; apply standardizing rules to generate the visual display characteristics of the relationships based on their logical classification and their strength values;
at least one data storage device configured to store idea map and related data;
at least one display unit configured to:
create a display of the said ideas as idea boxes using the standardized visual display characteristics and showing name/title and one or more of the following predefined information categories: What, When, Who, and Where; create a display of the said relationships among the said idea boxes as lines or arrows using the standardized visual display characteristics;
at least one data input device configured to input idea map data;

18. The computer-implemented system of claim 15, wherein the display unit is further configured to allow zoom and pan of the Visual idea map.

19. The computer-implemented system of claim 15, wherein at least one computer is configured to operate in a distributed computer system network.

20. A computer program product embodied in a computer readable medium for processing and displaying visual idea maps comprising instructions for performing the method of claim 1.
